(19) United States
(12) Patent Application Publication
(10) Pub. No.: US 2006/0041477 A1
(43) Pub. Date: Feb. 23, 2006

(54) System and method for providing targeted information to users

(76) Inventor: Zhiliang Zheng, Sunnyvale, CA (US)

Correspondence Address: PERKINS COIE LLP, P.O. BOX 2168, MENLO PARK, CA, 94026, US

(21) Appl. No.: 11/206,487

(22) Filed: Aug. 17, 2005

Related U.S. Application Data
(60) Provisional application No. 60/602,688, filed on Aug. 17, 2004.
(60) Provisional application No. 60/622,659, filed on Oct. 27, 2004.
(60) Provisional application No. 60/623,980, filed on Nov. 1, 2004.
(60) Provisional application No. 60/669,209, filed on Apr. 7, 2005.
(60) Provisional application No. 60/694,319, filed on Jun. 27, 2005.

(51) Int. Cl. G06Q 30/00

(52) U.S. Cl. 705/14

(57) ABSTRACT

A technique for providing targeted information to users involves using demographic or specific user data. Each user may have some demographic data associated with them, which may be compared to, by way of example but not limitation, another user, a product, information, a location, or other goods or services. Promotions that take demographic information into account can be effective in presenting information to a user, which is more beneficial to both the user and a vendor or expert associated with the promotion. Specific user information can be used to address specific user needs.

### CROSS-REFERENCE TO RELATED APPLICATIONS

This Application claims the benefit of U.S. Provisional Application No. 60/602,688 filed on Aug. 17, 2004, U.S. Provisional Application No. 60/622,659, filed on Oct. 27, 2004, U.S. Provisional Application No. 60/623,980, filed on Nov. 1, 2004, U.S. Provisional Application No. 60/669,209, filed on Apr. 07, 2005, and U.S. Provisional Application No. 60/694,319, filed on Jun. 27, 2005, each of which are incorporated by reference.

### BACKGROUND

Advertising using traditional media, such as television, radio, newspapers and magazines, is known. Advertisers have used these types of media to reach a large audience with their advertisements. To reach a more responsive audience, advertisers have used demographic studies. For example, advertisers may use broadcast events such as football games to advertise beer and action movies to a younger male audience. However, even with demographic studies and entirely reasonable assumptions about the typical audience of various media outlets, advertisers recognize that much of their ad budget is simply wasted because the target audience is not interested in the advertisement that the target audience is receiving.

Interactive media, such as the Internet, has the potential for better targeting of advertisements. For example, some websites provide an information search functionality that is based on query keywords entered by the user seeking information. This user query can be used as an indicator of the type of information of interest to the user. By comparing the user query to a list of keywords specified by an advertiser, it is possible to provide some form of targeted advertisements to these search service users. The effectiveness may be limited to sites where the user enters a search query to indicate their topic of interest.

More accurately targeting information is a problem that continues to be the subject of research and development in the advertising and e-commerce industries. Inventions that improve the targeting of information are of great economic value.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for providing targeted information to users involves using demographic or specific user data. Each user may have some demographic data associated with them, which may be compared to, by way of example but not limitation, another user, a product, information, a location, or other goods or services. Promotions that take demographic information into account can be effective in presenting information to a user, which is more beneficial to both the user and a vendor or expert associated with the promotion. Specific user information can be used to address specific user needs.

An example of a factor that may be of importance to a user in general, or to a user of a particular demographic, is providing information and advertisements in a timely manner, particularly information and advertisements that are timing-critical.

An example of another factor that may be of importance to a user in general, or to an advertiser of goods or services, is direct selling to a demographic with minimum product inventory. Assuming the advertiser has better information regarding consumer demographics, an advertiser may take advantage of such information. Vendors may be willing to provide discounts to advertisers with good demographic information because the advertisers can be more effective in their targeting of consumers who would want a given good or service. Advertisers with improved demographic information may be able to maintain more accurate inventories, thereby avoiding large storage costs, or to even go without inventory if acting as a conduit for a vendor. This ability may be further augmented by the ability to predict sales that are highly likely for a given user or group of users.

An example of another factor that may be of importance to a user in general, or to an advertiser of goods or services, is customer-specific advertising. Demographic or specific knowledge about a user or group of users can vastly improve advertising effectiveness and efficiency. It is particularly important to provide hard copies of advertisements to those consumers that are likely to buy a given good or service, due to the expense associated with hard copies. Thus, targeted information can reduce costs for both soft copy and hard copy advertisement.

An example of another factor that may be of importance to a user in general, or to an advertiser of goods or services, is taking advantage of one-to-one marketing. Users can specify what goods or services that interest them. Demographic or specific knowledge about a user can improve the prompts to obtain such user information, thereby benefiting both the user and the vendor of the goods or services.

An example of another factor that may be of importance to a user in general, or to an advertiser of goods or services, is taking advantage of referrals. Users who are effectively targeted may be willing to provide referrals to other users, as a favor, for personal profit, or both. Referrals can be accompanied by, for example, a linked ranking that would be tuned to the demographic or specific information associated with the sender of the referral or the receiver.

An example of another factor that may be of importance to a user in general, or to a user of a particular demographic, is user needs oriented promotions. By addressing user needs, information can be more effectively targeted. User needs may be ascertained from a user who has indicated an interest, or from needs that are derived from demographic information, such as by way of example but not limitation, needed information regarding immigration for immigrant groups or information related to obtaining a drivers' license for users who have reached or will soon reach the legal age to drive.

The proposed system can offer, among other advantages, a dynamic referral system with rewards based upon, by way of example but not limitation, time, relatedness of referree and referrer, hierarchical considerations, item associations, or other factors. These and other advantages of the present invention will become apparent to those skilled in the art upon a reading of the following descriptions and a study of the several figures of the drawings.

### BRIEF DESCRIPTION OF THE DRAWINGS

Embodiments of the invention are illustrated in the figures. However, the embodiments and figures are illustrative rather than limiting; they provide examples of the invention.

FIG. 1 depicts a networked system that includes several computer systems coupled together through a network.

FIG. 2 depicts a computer system for use in the system of FIG. 1.

FIG. 3 depicts an example of a device effective for providing targeted information.

FIG. 4 depicts an example of a user needs database.

FIGS. 5A and 5B depict an example of a promotions database.

FIG. 6 depicts a flowchart of an example of a method for providing referrals.

FIG. 7 depicts a flowchart of an example of a method for linked ranking.

FIG. 8 depicts a flowchart of an example of a method for user oriented promotion presentation.

FIG. 9 depicts a flowchart of an example of a method for obtaining user needs.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

The teachings provided herein may be implemented on a variety of platforms. For example, embodiments may be implemented on a platform that includes a universal network marketing system, such as described in U.S. patent application Ser. Nos. 11/142,516; 11/142,510; 11/141,781; and 11/142,634, each of which was filed on May 31, 2005, and each of which is incorporated by reference. Alternative examples of applicable systems are described with reference to the following figures. It should be understood that various aspects and embodiments could be implemented on other systems, as well.

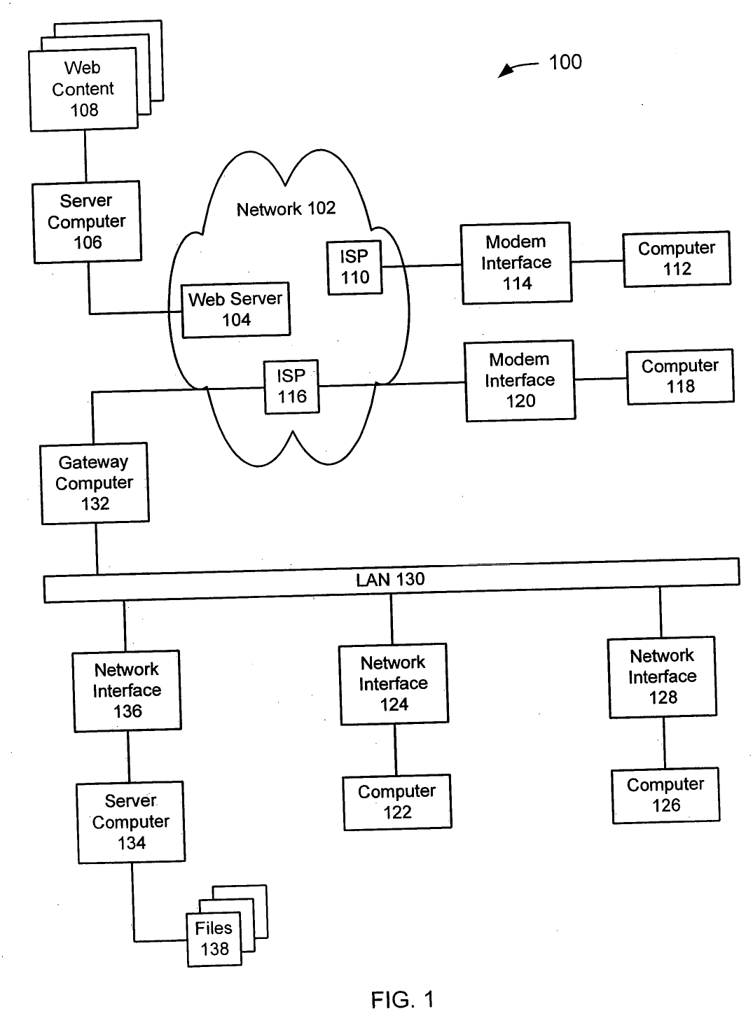

FIG. 1 depicts a networked system 100 that includes several computer systems coupled together through a network 102, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). The physical connections of the Internet and the protocols and communication procedures of the Internet are well known to those of skill in the art.

The web server 104 is typically at least one computer system which operates as a server computer system and is configured to operate with the protocols of the World Wide Web and is coupled to the Internet. The web server system 104 can be a conventional server computer system. Optionally, the web server 104 can be part of an ISP which provides access to the Internet for client systems. The web server 104 is shown coupled to the server computer system 106 which itself is coupled to web content 108, which can be considered a form of a media database. While two computer systems 104 and 106 are shown in FIG. 1, the web server system 104 and the server computer system 106 can be one computer system having different software components providing the web server functionality and the server functionality provided by the server computer system 106, which will be described further below.

Access to the network 102 is typically provided by Internet service providers (ISPs), such as the ISPs 110 and 116. Users on client systems, such as client computer systems 112, 118, 122, and 126 obtain access to the Internet through the ISPs 110 and 116. Access to the Internet allows users of the client computer systems to exchange information, receive and send e-mails, and view documents, such as documents which have been prepared in the HTML format. These documents are often provided by web servers, such as web server 104, which are referred to as being “on” the Internet. Often these web servers are provided by the ISPs, such as ISP 110, although a computer system can be set up and connected to the Internet without that system also being an ISP.

Client computer systems 112, 118, 122, and 126 can each, with the appropriate web browsing software, view HTML pages provided by the web server 104. The ISP 110 provides Internet connectivity to the client computer system 112 through the modem interface 114, which can be considered part of the client computer system 112. The client computer system can be a personal computer system, a network computer, a web TV system, or other computer system. While FIG. 1 shows the modem interface 114 generically as a “modem,” the interface can be an analog modem, isdn modem, cable modem, satellite transmission interface (e.g. “direct PC”), or other interface for coupling a computer system to other computer systems.

Similar to the ISP 114, the ISP 116 provides Internet connectivity for client systems 118, 122, and 126, although as shown in FIG. 1, the connections are not the same for these three computer systems. Client computer system 118 is coupled through a modem interface 120 while client computer systems 122 and 126 are part of a LAN 130.

Client computer systems 122 and 126 are coupled to the LAN 130 through network interfaces 124 and 128, which can be Ethernet network or other network interfaces. The LAN 130 is also coupled to a gateway computer system 132 which can provide firewall and other Internet-related services for the local area network. This gateway computer system 132 is coupled to the ISP 116 to provide Internet connectivity to the client computer systems 122 and 126. The gateway computer system 132 can be a conventional server computer system.

Alternatively, a server computer system 134 can be directly coupled to the LAN 130 through a network interface 136 to provide files 138 and other services to the clients 122 and 126, without the need to connect to the Internet through the gateway system 132.

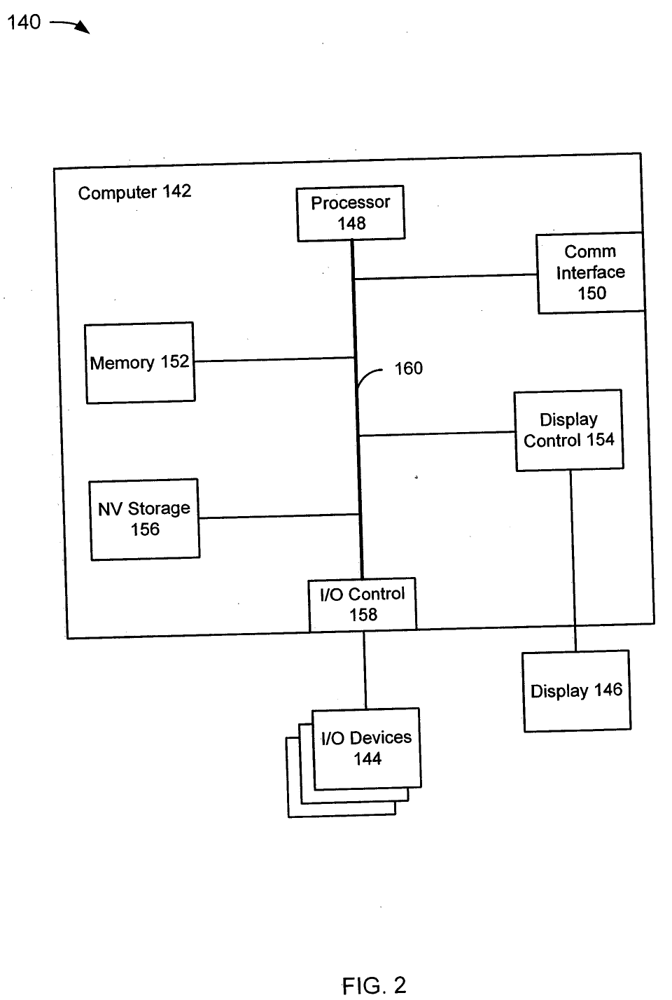

FIG. 2 depicts a computer system 140 for use in the system 100 (FIG. 1). The computer system 140 may be a conventional computer system that can be used as a client computer system or a server computer system or as a web server system. Such a computer system can be used to perform many of the functions of an Internet service provider, such as ISP 110 (FIG. 1). The computer system 140 includes a computer 142, I/O devices 144, and a display device 146. The computer 142 includes a processor 148, a communications interface 150, memory 152, display controller 154, non-volatile storage 156, and I/O controller 158. The computer system 140 may be couple to or include the I/O devices 144 and display device 146.

The computer 142 interfaces to external systems through the communications interface 150, which may include a modem or network interface. It will be appreciated that the communications interface 150 can be considered to be part of the computer system 140 or a part of the computer 142. The communications interface can be an analog modem, ISDN modem, cable modem, token ring interface, satellite transmission interface (e.g. “direct PC”), or other interfaces for coupling a computer system to other computer systems.

The processor 148 may be, for example, a conventional microprocessor such as an Intel Pentium microprocessor or Motorola power PC microprocessor. The memory 152 is coupled to the processor 148 by a bus 160. The memory 152 can be Dynamic Random Access Memory (DRAM) and can also include Static RAM (SRAM). The bus 160 couples the processor 148 to the memory 152, also to the non-volatile storage 156, to the display controller 154, and to the I/O controller 158.

The I/O devices 144 can include a keyboard, disk drives, printers, a scanner, and other input and output devices, including a mouse or other pointing device. The display controller 154 may control in the conventional manner a display on the display device 146, which can be, for example, a cathode ray tube (CRT) or liquid crystal display (LCD). The display controller 154 and the I/O controller 158 can be implemented with conventional well known technology.

The non-volatile storage 156 is often a magnetic hard disk, an optical disk, or another form of storage for large amounts of data. Some of this data is often written, by a direct memory access process, into memory 152 during execution of software in the computer 142. One of skill in the art will immediately recognize that the terms “machine-readable medium” or “computer-readable medium” includes any type of storage device that is accessible by the processor 148 and also encompasses a carrier wave that encodes a data signal.

The computer system 140 is one example of many possible computer systems which have different architectures. For example, personal computers based on an Intel microprocessor often have multiple buses, one of which can be an I/O bus for the peripherals and one that directly connects the processor 148 and the memory 152 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 152 for execution by the processor 148. A Web TV system, which is known in the art, is also considered to be a computer system according to the present invention, but it may lack some of the features shown in FIG. 2, such as certain input or output devices. A typical computer system will usually include at least a processor, memory, and a bus coupling the memory to the processor.

In addition, the computer system 140 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 156 and causes the processor 148 to execute the various acts required by the operating system to input and output data and to store data in memory, including storing files on the non-volatile storage 156.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

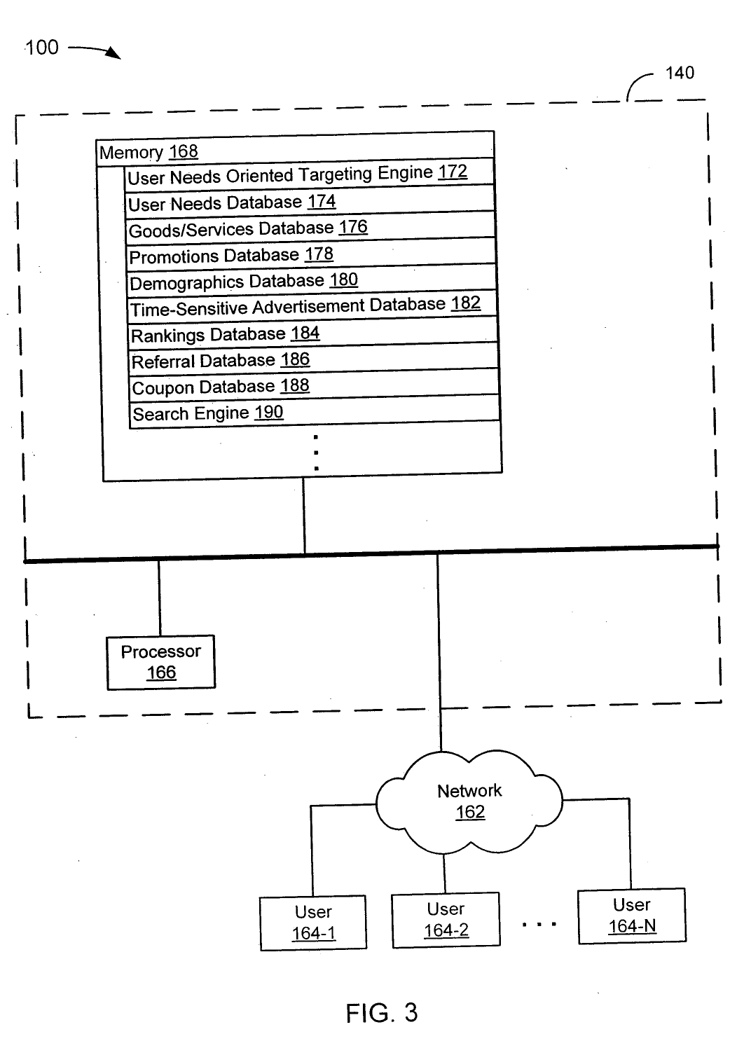

FIG. 3 depicts an example of a device 140 effective for targeting information. The device 140 includes a processor 166, a memory 168, and a bus 170 operationally connecting the processor 166 to the memory 168. The processor 166 is effective to execute code or access data that is stored in the memory 168 in a manner that is well-known.

In the example of FIG. 3, the memory 168 includes a user needs oriented targeting engine 172, a user needs database 174, a goods/services database 176. The memory 168 may also include additional optional databases including, by way of example but not limitation, a promotions database 178, a demographics database 180, a time-sensitive advertisement database 182, a rankings database 184, a referral database 186, a coupon database 188, and a search engine 190. The databases include entries. These entries may be stored as records in a conventional database, as objects in an object-oriented system that functions as a database, or in some other manner that is effective to store data for reliable maintenance and access. The databases may be maintained locally, at a remote location, or at multiple locations. Each entry is associated with one or more fields that include data. As used herein, a field is a general term for a data set found in a record of a database, an array of an object, or some other data structure or group of data structures that is stored in association with the entry.

In the example of FIG. 3, the user needs database 174 is effective to include a plurality of user needs database entries. In an embodiment, each user needs database entry is associated with a user and includes a contact field and an interest field. The contact field includes data sufficient to contact the user. In an aspect of this embodiment, the contact field includes data such as, by way of example but not limitation, a phone number, an email address, or some other data that is effective as both an identifier of the user and contact data. Thus, the user needs database entry is associated with the user because the user can be identified thereby. Alternatively, the contact field may include some other data that does not directly identify the user, such as a web site, a bulletin board, or a mailing list. In this case, the user needs database entry may include a user field that has data sufficient to identify the user. For example, the user field could be a name, a serial number, a login ID, a user ID, a login name, or some other user-specific data. In another alternative, the user field and the contact field could be sufficient to redundantly identify the user. The interest field may include data related to goods or services that may be of interest to the user. The data may include specific items or models that the user indicated an interest in, or classes of goods or services. The data may be derived from the user's activities or by demographic data associated with the user, or the user may have explicitly indicated the interest. The user needs database entries may include other fields, which need not be described to understand the principles described herein.

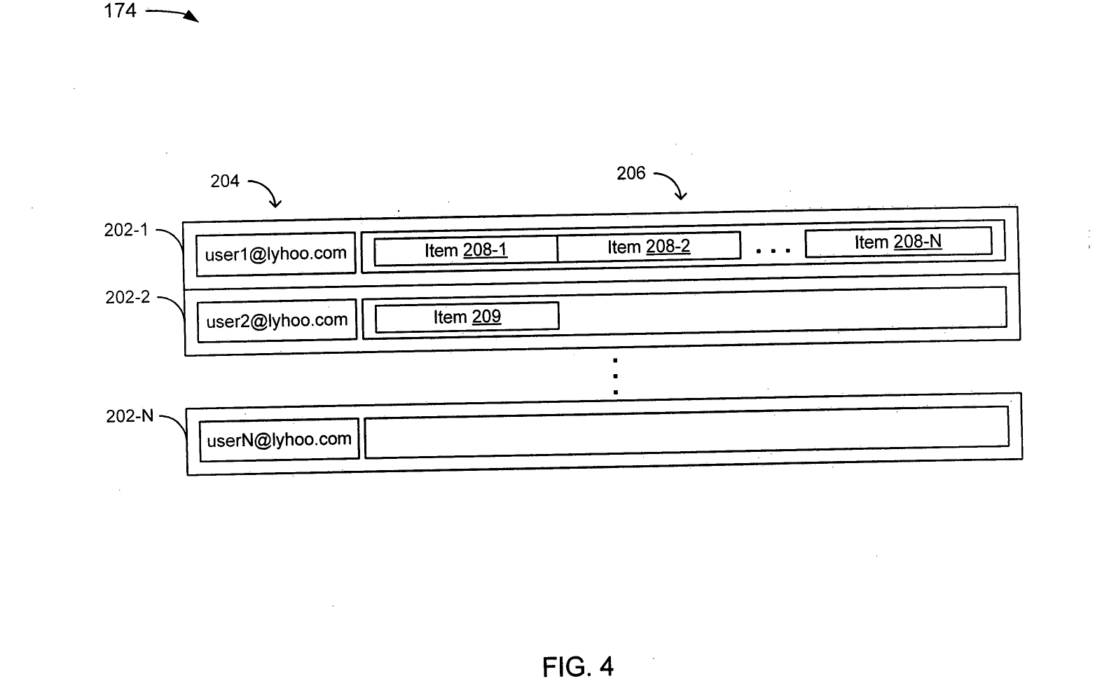

FIG. 4 depicts an example of a user needs database 174. The user needs database 174 includes a plurality of user needs database entries 202-1 to 202-N (referred to hereinafter collectively as the user needs database entries 202). Each of the user needs database entries 202 include a plurality of fields. In the example of FIG. 4, the fields include a contact field 204 and an interest field 206. The contact field 204 includes an email address, which is but one of a myriad of ways to contact a user or to facilitate contact of a user. The interest field 206 includes a plurality of sub-fields for identifying various goods and/or services. In the example of FIG. 4, the user associated with the email address user1@lyhoo.com has multiple sub-fields in the interest field 206, which are depicted as items 208-1 to 208-N (referred to hereinafter collectively as the items 208). For illustrative purposes, the user associated with the email address user2@lyhoo.com has one sub-field in the interest field 206, which is depicted as item 209, and the user associated with the email address userN@lyhoo.com has no items of interest. Due to the great number of possible user interests in goods and services, it may be desirable to maintain the sub-fields dynamically. That is, each user needs database entry may grow in size if a user has multiple interests. The detail of each item of interest may also vary greatly depending upon the specificity and type of item. Examples of more specific items of interest are described later.

Referring once again to FIG. 3, in operation, the user needs oriented targeting engine 172 targets a user to inform the user of goods and/or services in the goods/services database 176 that match the interests of the user, as identified in the user needs database 174. The goods/services database 176 can facilitate direct selling with minimum product inventory. For example, if one or more users have indicated an interest in the same good or service, the system 100 may attempt to purchase the good or service from a seller at a lower price than would normally be available through a retail channel by virtue of, for example, the number of orders for the item by users of the system 100. The system 100 may take into account a common, average, or maximum purchase price in making offers to sellers. The sellers may lower their prices to meet a demand by offering, for example, coupons to potential buyers who have indicated an interest in the good or service at a particular price. This can lead to improved targeting of consumers who have already expressed an interest in the product. Among other advantages, this tends to reduce the “junk” nature of advertisements to particular users. This also typically keeps the product inventory lower for the intermediary running the system 100. In an embodiment, the intermediary may also provide sales information to companies regarding potential sales so that the companies can also keep their inventories at a beneficial level.

Improved targeting can lead to time and cost-savings for generating a brochure of customer-specific advertisements (in soft or hard copy). The brochure may be printed as an e-magazine or an actual catalog with customer-specific advertisements presented as images, tables, figures, or other forms that aid the customer in deciding upon a purchase. The advertisements may include ads that were provided by a company, found with a search, created internally, or generated from referrals by other users. The customer-specific catalogs may include recommendations that are related to identified user needs, thereby taking advantage of cross-selling of advertisements. The catalogs may be sent to the user electronically or by post. One or more of the advertisements in the catalog could include a coupon identification number so that the consumer can make a purchase using the coupon. Users who make referrals may be rewarded if the consumer makes use of a coupon associated with their referral. Online advertisements may include links to, for example, a seller's website. The advertisements may include a status that identifies deadlines to act or other information. The catalog may include both coupons that are available to everyone (or a demographic) and coupons that are customer-specific, such as referrals from acquaintances.

Advantageously, other engines and databases can be used to target users in a time-sensitive, promotion-driven, demographics-driven, referral-driven, or other manner. The specificity possible with the system described herein permits ranking of goods or services by users that can be applied to the interests of other users, thereby improving the value of the rankings. This can lead to more efficient use of a promotions database to target users with promotions and advertising.

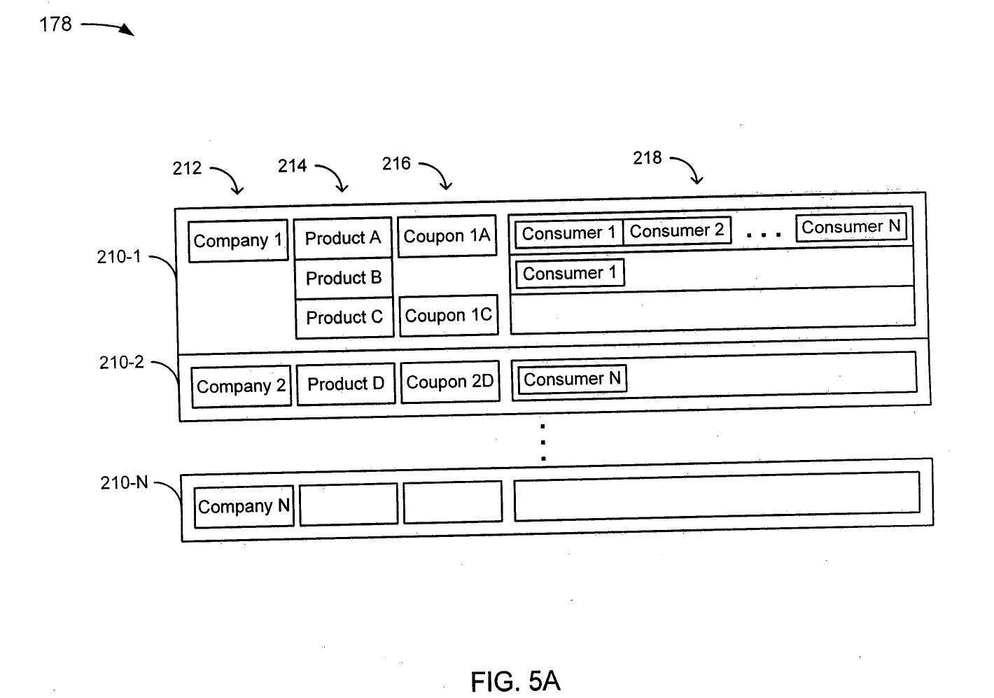

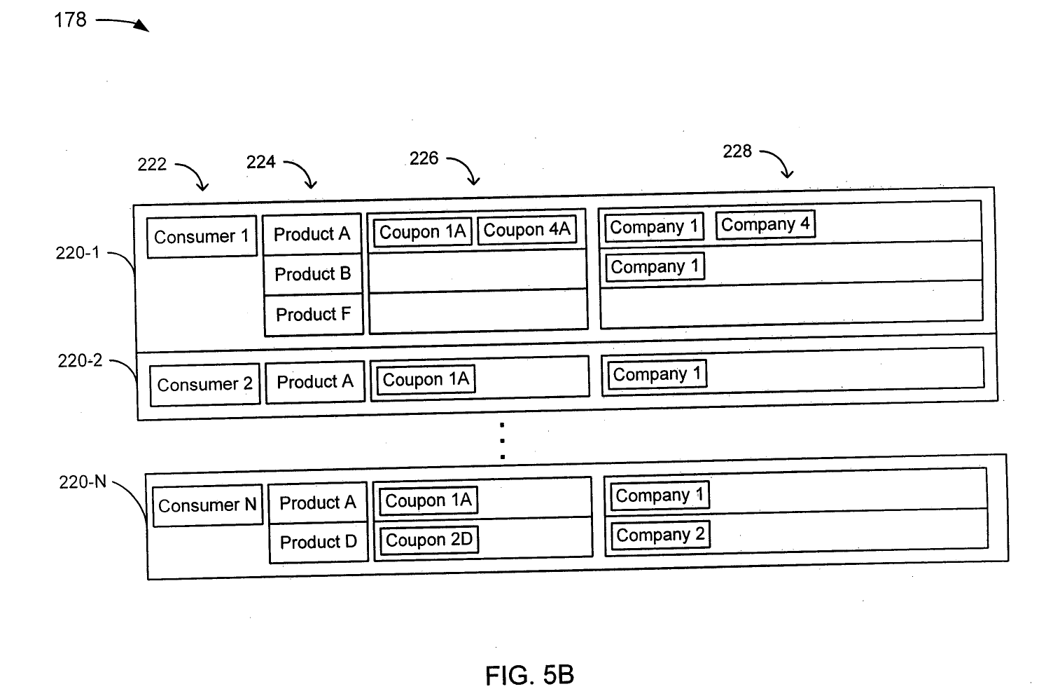

FIGS. 5A and 5B depict an example of a promotions database 178. In the example of FIG. 5A, the promotions database 178 has a promoter-based index. In the example of FIG. 5B, the promotions database 178 has a consumer-based index. The databases may or may not be logically combined, but for the purposes of example, the promotions database 178 is generally referred to herein as a combination of the promoter-based and consumer-based indexes, which are treated as interchangeable. In alternative embodiments, the promotions database 178 may actually be split into two databases similar to those depicted in the examples of FIGS. 5A and 5B.

In the example of FIG. 5A, the promotions database 178 is shown as including promotions database entries 210-1 to 210-N (referred to hereinafter collectively as the promotions database entries 210). In the example of FIG. 5A, each of the promotions database entries 210 have a company field 212, a product field 214, a coupon field 216, and a consumer field 218. For the purposes of illustration, the company field associated with the promotions database entry 210-1 includes an identifier of “Company 1”. The product field may include a list of products such as, for the purposes of illustration, “Product A”, “Product B”, and “Product C”. For the purposes of illustration, the promotions database entry 210-1 includes coupon 1A (Company 1, Product A) and coupon 1C (Company 1, Product C). A coupon may be for a particular good or service or for a class or sub-class of a good or service. The coupon may include a sale price or a discount on a good or service. A coupon may or may not include a serial number or coupon code to uniquely (or generally) identify the coupon, possibly to determine the origin of the coupon. For the purposes of illustration, “Product B” does not have an associated coupon. For the purposes of illustration, the promotions database entry 210-1 includes an identifier of Consumers 1 to Consumers N, which are associated with Product A (as shown by being entered on the same line as Product A in the example of FIG. 5A). The association between the consumers and the product, the company, or both is made by, by way of example but not limitation, comparing user needs in the user needs database 174 with goods or services in the goods/services database to find a match. If any coupons are available, the user may be made aware of the coupons along with the availability of the good or service. Alternatively, the user may be made aware of the good or service only if a coupon is available. The notification of the user that a match has been made may be determined by an administrator, it may be configurable by the user, or there may be some automated procedure in place.

In the example of FIG. 5B, the promotions database 178 is shown as including promotions database entries 220-1 to 220-N (referred to hereinafter collectively as the promotions database entries 220). The promotions database entries 220 include a consumer field 222, product field 224, coupon field 226, and company field 226. For the purposes of illustration, the consumer field associated with promotions database entry 220-1 includes an identifier of “Consumer 1”. The product field may include a list of products such as, for the purposes of illustration, “Product A”, “Product B”, and “Product F”. For the purposes of illustration, the promotions database entry 220-1 includes coupon 1A (Company 1, Product A) and coupon 4A (Company 4, Product A). For the purposes of illustration, the promotions database entry 220-1 includes “Company 1” and “Company 4” in association with the relevant products (as shown by being entered on the same line as the relevant products).

In operation, the device 140 (FIG. 3) can use the promotions database 178 to match not only goods and services to users based upon the users' needs, but also to match promotions. For example, an Internet-scouring device, such as a spider, could gather information related to promotional material for presentation to a user. Alternatively, companies could voluntarily enter their promotional coupons into the database using a submission procedure or some other procedure.

Advantageously, the promotions database 178 facilitates customer-oriented advertisements and one-to-one marketing. Using the promotions database 178, advertising changes from a passive approach to an active approach where buyers identify their needs. Based on their needs, the user needs oriented targeting engine 172 can provide the advertisements to which the users will be most receptive. In an embodiment, the advertisements may even be sent in a manner that the user prefers (email, TV signal, hard copy printed material, or other communication channel). As a result of the targeting, the user is more likely to respond favorably to the advertising.

In an embodiment, the user needs oriented targeting engine 172 may use the promotions database 178 in two tables similar to the tables depicted in the examples of FIGS. 5A and 5B. The user needs oriented targeting engine 172 matches items the user needs with goods and services a company provides. Since it can be determined what buyers want and what sellers can provide, one-to-one marketing can be achieved. Sellers may be provided with information that is useful to decide what items would be most valuable to provide, or to which group of users to advertise. Cross-selling and up-selling can be enhanced.

The user needs targeting engine 172 may provide a user interface to present items to a user. In an embodiment, the user needs targeting engine 172 may reserve a portion of its user interface to present products/service that a user may be interested in (i.e., a cross selling opportunity). In another embodiment, the user needs targeting engine 172 may present advertisements intended to anticipate the user's interests. For example, if a user is looking for a coupon for a Dell laptop, the user needs targeting engine 172 can predict that the buyer may also be interested in a DELL printer. As a result, the user needs targeting engine 172 can present the latest advertisements, coupons, bonus points, product release information on various DELL printers to the user. The presentation of this information can be done in a reserved area of the interface so that the information won't interfere with the user's shopping experience.

In another embodiment, the user needs targeting engine 172 can present a list of categorized items and their related information to the user. For example, when a user is attempting to obtain information about a ballet performance (e.g., the location of the performance and/or any specials for the ballet performance), the user needs targeting engine 172 can deduce that the buyer is interested in the performance. The user needs targeting engine 172 can then present the buyer with categorized information on this performance such as, for example, Type of Performance, Actors, Location, and Parking information.

In another embodiment, the user needs targeting engine 172 may be implemented to respect a user's privacy by requiring all communications between a buyer and a seller to go through the user needs targeting engine 172 unless the buyer requests direct communication with a seller and obtains the permission of the user needs targeting engine 172 to do so. Additional privacy is afforded because the user can choose what type of advertisements, products, companies, and brands that the user is interested in and block all other advertisements (e.g., via a user request). Ads can be served or sent to a user through the user needs targeting engine 172. In one embodiment, with user permission, the ads can be served/sent to user through any third-party, including the seller.

Ad selection can be done in the background since the user needs targeting engine 172 may use user's stored information. The user needs targeting engine 172 may select advertisements, promotions, production information for a user regardless of whether the user is using the network device or not using the network device. Then the user needs targeting engine 172 may send/present/serve the selected information to user, or keep the selected information in the user's account. Notably, this is different from traditional search engines that typically do their searching (or selecting) while a user is actively online.

Advantageously, a Virtual Link can be built through the user needs targeting engine 172 between commercial companies and their potential customers. This link allows a company (even small company) to build its own virtual sales force for any product, for even low-priced or low margin goods and services.

Some companies may wish to target a particular demographic. Advantageously, promotions may be matched to the demographics database 180. The demographics database 180 may, in an embodiment, actually be a part of the user needs database 174, where demographics data is associated with each user. However, for the purpose of example, the demographics database 180 is treated as a distinct database.

Promotions or advertisements may be time-sensitive. Such promotions may be entered into the time-sensitive advertisement database 182 and matched to users based upon indicated need. The time to respond may or may not also be provided to the user. Advantageously, users may be provided with time-critical advertising that they might miss if the system 100 were not actively searching for and tracking the ads. For example, www.techbargains.com might have a short-term promotion for Dell Home Notebook Computers on Aug. 17, 2004. A user might not be aware of the ad or might forget to act upon the ad on the given date. The system 100, on the other hand, can scan various web sites for promotions, match the promotions to user needs, and identify the promotions to the user when the promotions become available, or compiled in a list, including dates on which to act. The notification may be provided to the user however the user prefers, such as, by way of example but not limitation, IM, email, cell-phone, or other notification means. The users may indicate they wish to make a purchase, either now or in the future, and the system 100 can execute the transaction at the indicated time.

The search for timing-critical advertisements may be conducted by searching sites of companies identified in the user needs database 174 as preferred companies, or sites that are preferred by the user. The system 100 can match buyers to sellers based upon a user profile in the user needs database 174 and company profiles in the goods/services database 176. In an embodiment, the system 100 may include a search engine 190 that searches for advertisements. The search engine 190 may or may not search for items available from sources other than from sellers having an account or with listings in the goods/services database 176. In an aspect of this embodiment, some or all of the search may be performed by a computer, while some of the search is performed by a human being.

Users, automated agents, or others may rank items based upon utility, popularity, price, or other factors. The rankings may be entered into the rankings database 184. Advantageously, since information about the users are known, rankings can be augmented with, by way of example but not limitation, demographic data. In this way, users of a first demographic may receive rankings that are different from users of a second demographic for an identical item or category of items.

Users may provide referrals of items to other users. Data associated with a referral may be stored in the referral database 186. Referrals may or may not be rewarded according to one or more criteria. By way of example but not limitation, a user who makes a referral may be rewarded based upon how quickly the referred user responds to the referral, or the user who makes a referral may be rewarded for referrals made by the first user who responds to the referral, thereby rewarding a user for descendants of an initial referral. Rewards may be tracked by increasing credit of the user. Additional rewards may be provided if the credit reaches a threshold value.

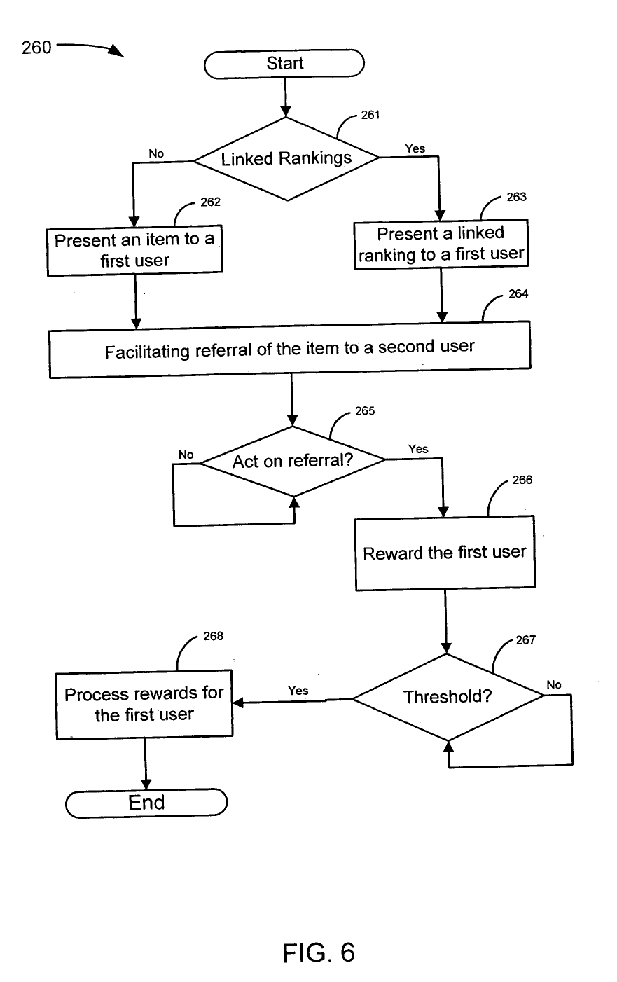

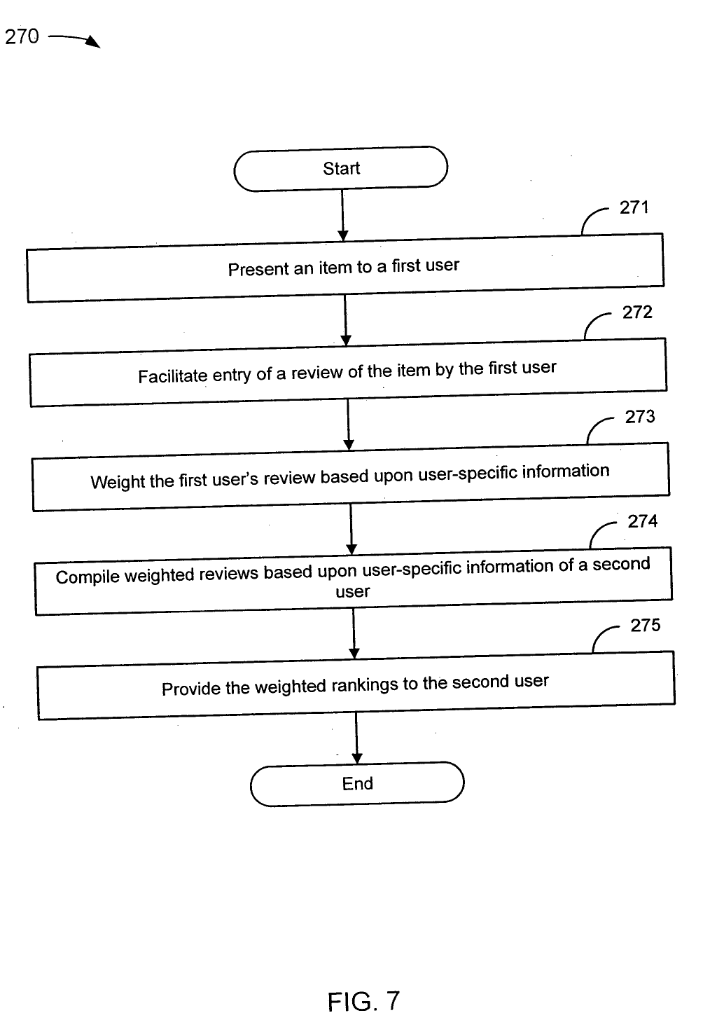

FIG. 6 depicts a flowchart 260 of an example of a method for providing referrals. In the example of FIG. 6, the flowchart 260 starts at decision point 261 where it is determined whether linked rankings are in effect. Linked rankings are optional. So, in an embodiment, linked rankings may not be available. In embodiments where linked rankings are available, a user may or may not be able to request linked rankings. An example of linked ranking is described later with reference to FIG. 7.

In the example of FIG. 6, if at decision point 261 it is determined that linked ratings are not available or are not requested (261-N), then at block 262 an item is presented to a first user. On the other hand, if at decision point 261 it is determined that linked rankings are available and are requested, or are automatically available (261-Y), then at block 263 a linked ranking is presented to the first user. In either case, the flowchart 260 continues at block 264 wherein the first user is given the opportunity to refer the item to a second user. The item may be goods (e.g., a product, promotion for a product, advertising alert, etc.) or a service (e.g., a service provider, an event, a promotion for a service, an advertising alert, or an expert task). In one or more embodiments, items are intended to encompass any good or service. At block 262, the item may or may not be presented to multiple first users, and/or multiple items may or may not be presented to the first user(s). At block 263, the linked ranking may or may not be presented to multiple first users (e.g., first users who share a demographic detail), and/or multiple linked rankings may or may not be presented to the first user(s). At block 264, the first user may or may not refer the item or linked ranking to multiple second users, and/or multiple items or linked rankings may be referred to the second user(s).

In the example of FIG. 6, the flowchart 260 continues at decision point 265 where it is determined whether the second user acts on the referral. The first user may be motivated to encourage the second user to act on a referral because of the rewards. For example, if a coupon “$500 off of any Dell Laptop at www.lyhoo.com” is presented to the second user, the second user may not immediately purchase the computer. However, the first user, may encourage the second user to act because they will earn a reward of, for example, $20 if the second user acts. If the second user does not act on the referral (265-N), then the flowchart 260 does not proceed. It may be noted that referrals may have a “shelf life” that causes the flowchart 260 to eventually end if the second user does not act on the referral. Thus, in an embodiment, the first user may or may not be rewarded simply for making a referral. Alternatively, rewards may diminish if the second user takes longer to act on the referral. Alternatively, the referral may time out after some time and a reward may be provided to the first user even if the second user never acts on the referral.

In the example of FIG. 6, if the second user acts on the referral (265-Y), then the flowchart 260 continues at block 266 where the first user is rewarded. Acting on a referral may include purchasing a good or service associated with the referral, investigating the good or service, following a link to a web site and making a purchase that is either related or unrelated to the good or service for which the second user was referred, answering a questionnaire related to the referral, or performing some other affirmative action. The referral may or may not also invite the second user(s) to make use of the referring system, which, if acted upon, may have its own associated rewards for the first user. The first user may also be rewarded for indirect referrals (e.g., acted upon referrals by the second user to a third user).

In the example of FIG. 6, the flowchart 260 continues at decision point 267 where it is determined whether a rewards threshold has been met. The rewards threshold may be met every time a referral is acted upon (thus crediting an account with each referral acted upon) or the rewards threshold may be met after a certain number of referrals, or value of referrals, have been acted upon, or both (e.g., each referral that is acted upon may result in a credit, and after receiving a set number of credits, additional rewards may be earned). If at decision point 267 the rewards threshold is not met (267-N), then the flowchart 260 does not progress until additional referrals have been acted upon by the second or other users that have received referrals from the first user (or by third or other users who have received referrals from the second user that are related to the referral provided by the first user to the second user). Indirect referrals may have diminishing rewards as the distance from an initial referral increases.

Distance may be thought of as degrees of separation. For example, if the first user refers the second user, then the first and second user may be thought of as one degree separated. If the second user then refers a third user, the first and third users may be thought of as two degrees separated. Rewards to the first user may diminish according to the degrees of separation between them and a referred user. Alternatively or in addition, the first user may receive diminishing rewards over time so that faster referrals result in higher rewards than slower referrals.

In the example of FIG. 6, if at decision point 267 the rewards threshold is met (267-Y), then the flowchart 260 continues at block 268 where rewards for the first user are processed, and the flowchart 260 ends. It may be noted that if users are credited for each acted-upon referral, and additionally rewarded for a certain number or value of referrals, then the flowchart 260 may continue to loop at decision point 267 for the additional rewards, while simultaneously crediting the first user at block 268. For example, a user may receive credit for referrals, and earn, e.g., a new bicycle as a reward for amassing $5,000 worth of credit (in addition to the credits themselves) or, e.g., a new car for amassing $50,000 worth of credit. Also, additional rewards may be provided to the first user if the second user joins the referring system. The reward for joining the referral system may be instead of or in addition to the rewards for acting upon the referral.

Rewards may also be provided for checking a link associated with the first user. For example, the referral by the first user may include some identifier, such as a link to the first user's email, user account, or other location. If the second user checks the link to ensure that the referral is from the first user, the first user may be rewarded as if the second user had acted upon the referral. If the second user subsequently makes a purchase or joins the referral system, the rewards may be greater. If the first user is not identified in the referral, the second user may be asked for the first user's identity, and the first user may be rewarded without actually being explicitly linked to the referral.

FIG. 7 depicts a flowchart 270 of an example of a method for linked ranking. Linked rankings may allow, for example, a first user to over-ride general rankings about particular items. Since general rankings tend to be an average of all demographics and user inputs, general rankings may not accurately reflect the desirability of an item to a particular demographic. For example, a first user may love the DEVIL laptop even though general rankings rate it relatively low because the DEVIL laptop is generally believed to be not worth its hefty price. If a user is a “high-end game player, age 21, using high speed Internet”, and other users with the same associated demographic information rate the DEVIL laptop highly, then the linked rankings may reflect this. And another user who receives the referral from the user may be provided the linked rankings appropriate for their demographic. In an embodiment, linked rankings may be defined as rankings by users that a given user knows and/or trusts. Thus, rather than demographic information, a user may receive linked rankings from a user who the user has indicated they know or trust. This can improve the confidence a user has in the rankings of a given item. Alternatively, the linked ranking may combine the general ranking, demographic-weighted ranking, and/or known or trusted rankings using a formula. This would presumably be superior to a typical rating system that simply ranks goods or services based on an average of equally weighted votes it receives. Multiple ratings (e.g., unweighted rankings alongside trusted rankings) may be provided to a user who requests linked rankings.

In the example of FIG. 7, the flowchart 270 starts at block 271 where an item is presented to a first user. The flowchart 270 continues at block 272 where the first user submits a review of the item. The first user may be different from other users by virtue of differing demographics information, previous referrals to certain users, identification of known or trusted users, or other information. The first user's review of an item may be applied to a general review (where all reviews are weighted equally). Alternatively, or in addition, the flowchart 270 continues at block 273 where the first user's review of the item is weighted based upon user-specific information. For example, a self-described scientist who reviews a Sony Digital Camera may be given greater weight with respect to other scientists than to high school students. As another example, a user in California may have different expectations regarding products than a user in New York, which is but one example of demographics information (which may be derived from input by the user, from shipping information, or some other data). In the example of FIG. 7, the flowchart 270 continues at block 274 where the weighted reviews are compiled based upon the user-specific information associated with a second user, and at block 275 where the reviews are provided with weighted rankings to a second user.

Referring once again to FIG. 3, coupons may be recorded in the coupons database 188. The coupons can be provided to users in a manner that is consistent with user oriented promotions.

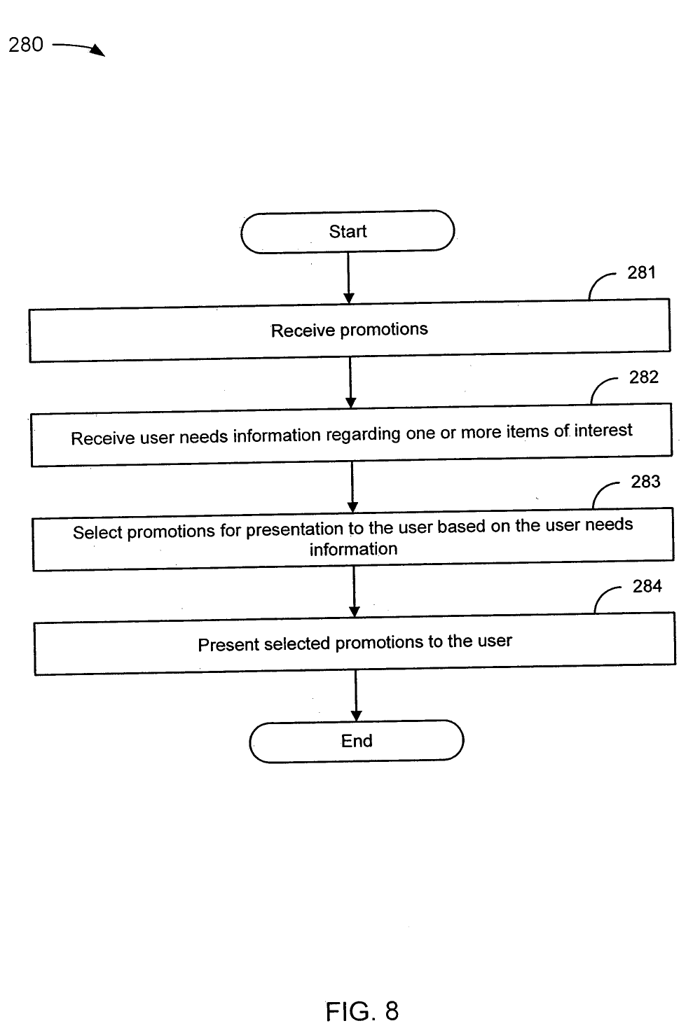

FIG. 8 depicts a flowchart 280 of an example of a method for user oriented promotion presentation. In the example of FIG. 8, the flowchart 280 starts at block 281 where promotions are received. Promotions may be received from advertisers who may specify items for promotion. The advertisers may also be able to specify items or categories that are related to the promoted items. Alternatively, the promotions may be obtained by searching websites and updating promotions as they are found. In this alternative, the advertiser may or may not be aware that their promotions are being provided. Promotions are generally used to advertise goods or services (including promoting events).

In the example of FIG. 8, the flowchart 280 continues at block 282 where user needs information regarding one or more items of interest to a user is received. The user may specify particular items of interest, items to buy, items to join, or categories of interest. For each item of interest, the user may be able to select whether to receive promotions related to the item. If it is determined that a particular promotion is of interest to a user, and advertising alert may be sent even if the user has indicated no interest in receiving a promotion. Advertising alerts may also be sent if the promotion is going to expire, or if there are a limited number of items associated with the item. The user may be able to specify criteria (e.g., one or more characteristics about an item, the time frame to receive a promotion, etc.) for selecting promotions. The user may be able to select a preferred client device on which to receive promotions. The user may be able to assign each item of interest to one or more relative categories of need based, by way of example but not limitation, on the relative need by the user for an item. The assigned items may then be organized into item lists according to the assigned category of need. The lists may be provided to the user in a user-selectable format so that the user can select and review items assigned to the same category.

In the example of FIG. 8, the flowchart 280 continues at block 283 where promotions are selected for presentation to the user based upon the user needs information. The selection is accomplished by matching user needs to items available. The selection of promotions may occur at any time (e.g., whether or not the user is currently accessing the service). Portions of the selecting process may be performed in whole or in part by a machine or a human being. In an embodiment, promotions may be analyzed to identify items associated with the promotion and items related to the promotion, and to link the associated items and related items with the promotion. This may facilitate the creation of a catalog for known items based on criteria associated with the promotions and/or items. The promotions can be categorized based on related and associated items, a sub-category may be generated for the related promotions. The linking of associated and related items can also facilitate an accurate and fast selecting process.

In the example of FIG. 8, the flowchart 280 continues at block 284 where selected promotions are presented to the user. The presenting may occur at any time (e.g., whether or not a client device can communicate via a network). For example, the user can check the promotions on a PlayStation Portable (PSP) while waiting in an airport. Selected promotions may be presented in lists based upon the category of the item. The selected promotions may also be stored for future reference.

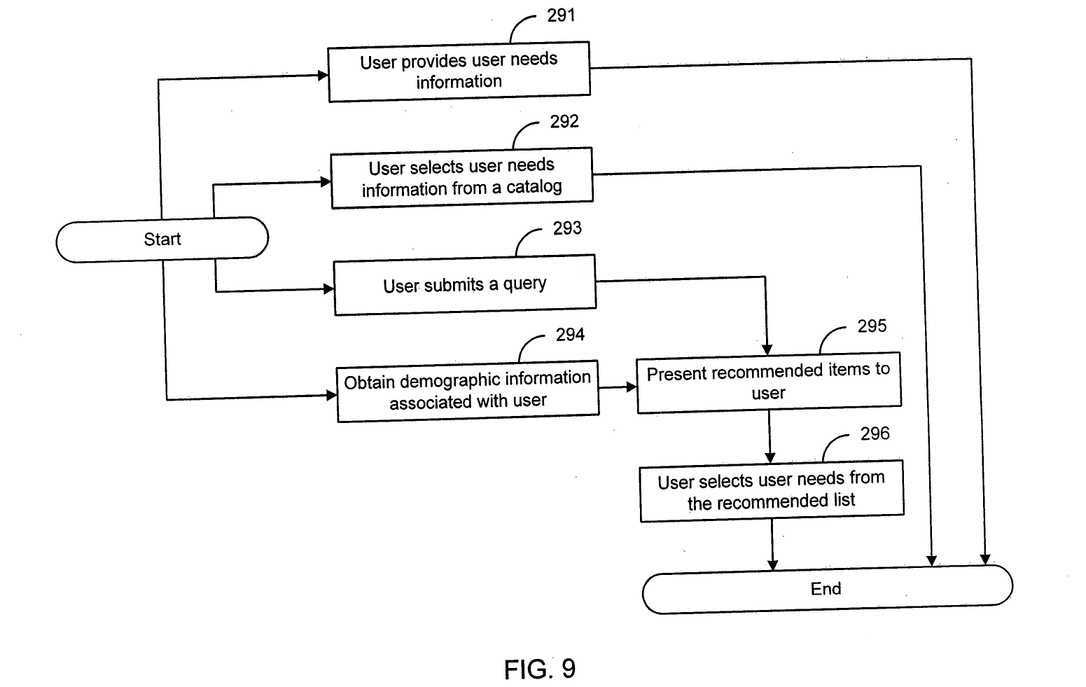

FIG. 9 depicts a flowchart 290 of an example of a method for obtaining user needs. In the example of FIG. 9, the flowchart 290 has four alternative exemplary blocks 291, 292, 293, and 294, which may occur simultaneously, intermittently, or not at all, depending upon the implementation and choices of users or agents. In block 291, a user provides user needs information. The user can specify what items are of interest, what items to buy, what items to do, demographic information, or other information. In block 292, a catalog of known items is provided to the user and to facilitate selection of one or more items of interest by the user. In block 293, a user may ask questions, and be provided with recommended items (at block 295) from which the user selects items of interest (at block 296). In block 294, demographic information associated with the user is obtained, and recommended items are provided to the user based upon the demographic information (at block 295) from which the user selects items of interest (at block 296). Demographic information may be obtained in any of a number of ways including, by way of example but not limitation, telephone interviews, electronic questionnaires, shipping information, in person interviews, previous purchases, Internet habits, etc.

The system described herein is expandable. Theoretically, any number of goods or services, with any degree of specificity or categorizations could be implemented. Moreover, companies could be granted licenses to use a platform of the system to build up their own customer-oriented advertisement, shopping experts, shopping lists, etc. Thus, other companies could submit expert solutions and have access to user-specific information, such as shopping profiles, though user privacy will preferably not be sacrificed.

As used herein, the term “embodiment” means an embodiment that serves to illustrate by way of example but not limitation.

As used herein, the term “item” may be defined to include any good or service (including an activity, event, or occurrence) that may be listed in a catalog, online, or in any other form. An item may include characteristics that may be used to categorize the item. An item may match another item if the characteristics of the items are similar. The match need not be an exact match. Rather, a match may be an indication of a relative degree of similarity or an absolute degree of similarity, or a degree of relatedness. The absolute degree of similarity may indicate belonging to a same category (e.g., a “food” category), same characteristic (e.g., costing over a certain amount of money), or other relationship (e.g., ink is related to printers). Matched items are considered to be related items.

As used herein, the term “promotion” may refer to advertisements, notices used to promote events, or brochures for presenting commercial or non-commercial information. Generally, promotions are used to advertise goods and services (including events). A promotion may or may not be directed to one or more items (e.g., a computer), associated with one or more items (e.g., a coupon for a monitor from a specific retail outlet), or about one or more items (e.g., a particularly sweet pineapple described in promotional literature). A promotion may or may not be associated with one or more advertisers (or identities of advertisers). Promotions for specific items may be treated as promotions for all related items.

As used herein, the term “advertisement” may refer to a variety of forms of promotions, including but not limited to standard print advertisements, online advertisements, audio advertisements, audio/visual advertisement, or any other type of sensory message desired by an advertiser. Advertisements may include advertising, promotions, coupons, bonus points, special offers, product releases, new products, product updates, or any other information.

As used herein, the term “product” includes real products and any commercial or non-commercial services that a company or individual can provide.

As used herein, the term “need” is akin to the term want.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A system comprising:
a user needs database effective to include a plurality of user needs database entries, wherein a user needs database entry is associated with a user, includes information to facilitate contacting the user, and includes information related to goods or services that may be of interest to the user;
a goods/services database effective to include a plurality of goods/services database entries, wherein a goods/services database entry includes information related to available goods or services; and
a user needs oriented targeting engine effective to:
utilize the information to facilitate contacting the user to target the user, and
utilize the information related to available goods or services and information related to goods or services that may be of interest to the user to provide to the targeted user information associated with available goods or services.

2. The system of claim 1, wherein the goods/services database entry identifies a good or service that is being promoted, wherein the user needs oriented targeting engine is effective to provide to the targeted user a promotion for the good or service based on the information related to goods or services that may be of interest to the user.

3. The system of claim 1, further comprising a promotions database including a promotions database entry associated with a first goods/services database entry and associated with a second goods/services database entry, wherein the first goods/services database entry identifies a good or service that is being promoted and the second goods/services database entry identifies a good or service that is related to the first entry.

4. The system of claim 1, wherein the user needs database entry further includes demographic data, further comprising:
a promotions database including a promotions database entry associated with a first goods/services database entry and associated with a second goods/services database entry, wherein the first goods/services database entry identifies a good or service that is being promoted and the second goods/services database entry identifies a good or service that is related to the first entry; and
a demographics database effective to include a demographics database entry, wherein the user needs oriented targeting engine identifies the second goods/services database entry as related to the first goods/services database entry using a demographics database entry to establish a relationship based on the demographic data in the user needs database entry.

5. The system of claim 1, further comprising:
a promotions database including a promotions database entry associated with the goods/services database entry, wherein the goods/services database entry identifies a good or service that is being promoted; and
a promotions engine effective to search for promotions and update the promotions database if a new promotion is found.

6. The system of claim 1, further comprising a user needs identification engine effective to obtain user needs information from users and update the user needs database if new information is obtained, wherein the user needs information includes data associated with goods or services of interest to the users.

7. The system of claim 1, further comprising a user needs identification engine effective to obtain user needs information from users and update the user needs database if new information is obtained, wherein the user needs information includes demographic data associated with the users.

8. The system of claim 1, further comprising a promotions analysis engine effective to link goods/services database entries to promotions for presentation to users.

9. The system of claim 1, further comprising a promotions analysis engine effective to link goods/services database entries to promotions that are related to goods or services that may be of interest to the user.

10. A method comprising:
receiving promotions;
receiving user needs information regarding one or more items of interest;
selecting promotions for presentation to the user based on the user needs information; and
presenting the selected promotions to the user.

11. The method of claim 10, wherein the user provides the user needs information.

12. The method of claim 10, wherein the user selects the user needs information from a catalog.

13. The method of claim 10, further comprising:
receiving a query from the user;
providing recommended items to the user; and
receiving from the user a selection of recommended items.

14. The method of claim 10, further comprising:
obtaining demographic information associated with the user;
providing recommended items to the user; and
receiving from the user a selection of recommended items.

15. A system comprising:
a means for maintaining user needs information;
a means for maintaining good/services information; and
a means for matching user needs information to goods/services information to target users associated with the user needs information with promotions.

16. The system of claim 15 further comprising a means for maintaining demographics information to improve targeting of users with promotions.

17. The system of claim 15 further comprising a means for maintaining time-sensitive advertisements to ensure timely targeting of users with promotions.

18. The system of claim 15 further comprising a means for maintaining a rankings database to ensure that targeted users receive ranking that are relevant based upon available user information.

19. The system of claim 15 further comprising a means for maintaining a referral database to reward users who help in the targeting of users with promotions.

20. The system of claim 15 further comprising a means for obtaining additional promotions for providing to users.
